(19) United States
(12) Patent Application Publication
(10) Pub. No.: US 2007/0049143 A1
(43) Pub. Date: Mar. 1, 2007

(54) Glass fiber non-woven fabrics, resin impregnated glass mats and methods for their manufacturing

(76) Inventors: Sean D'Silva, Englewood, CO (US); Thomas F. Stehlin, Kriftel (DE)

Correspondence Address: JOHNS MANVILLE, 10100 WEST UTE AVENUE, LITTLETON, CO, 80127, US

(21) Appl. No.: 11/503,024

(22) Filed: Aug. 11, 2006

(30) Foreign Application Priority Data
Aug. 23, 2005 (DE) 10 2005 039 709.3

(51) Int. Cl. B32B 5/02

(52) U.S. Cl. 442/59; 442/327; 442/149; 442/180

(57) ABSTRACT

Glass fiber non-woven fabrics, resin impregnated glass mats and methods for their manufacturing. The present invention relates to glass fiber non-woven fabrics comprising cut glass fibers, wherein the glass fiber non-woven fabric has an inhomogeneity of 10% or less, a weight per unit area of 600 g/m² or greater and a tensile strength of at least 10 N. The present invention also concerns resin impregnated glass mats which comprise the glass fiber non-woven fabrics according to the invention.

### BACKGROUND OF THE INVENTION

The invention relates to glass fiber non-woven fabrics, resin impregnated glass mats and methods for their manufacturing.

Resin impregnated glass mats, in particular sheet molding compounds (SMC) have long been used in technical fields. The manufacturing of SMCs and their further processing to components have also long been known. In typical SMC manufacturing processes, a layer of resin is initially applied to a foil. In the next step, cut fibers of reinforcing materials—usually glass fibers—are then applied to this resin layer. The cut fibers are produced in-line in that a relatively large number of glass fiber rovings are fed in and are cut with the aid of choppers. A further resin layer and a further foil complete the SMC manufacturing process.

After manufacturing of the SMC, a curing process lasting several days is necessary. During this time, chemical reactions take place which alter the viscosity of the resin and promote further impregnation of the fiber layer. During the subsequent pressing procedure, as a result of the shear forces acting, partial separation of the fiber bundle structure takes place.

Preferred SMCs have a high level of flowability which means that, for example, the compression mould may only have to be 30% to 50% covered. Added to this is the achievable surface quality, which can be up to class A level. Resin impregnated glass mats which comprise a woven textile or a fibrous web made from continuous fibers often have a reduced level of flowability. Resin impregnated glass mats of this type must therefore be introduced into the compression mould with a high degree of precision. Furthermore, the surface quality of the molded items made may be disadvantageously influenced by reinforcing mats of this type.

### SUMMARY OF THE INVENTION

The SMC manufacturing process with cut fibers as described is, as a rule, a relatively complex and slow process. As described, cut fibers are generally used for this and these fibers are made on site from rovings. A large number of bobbins, feed equipment and other devices is therefore needed, which involve a substantial labor input and can very readily lead to technical problems. The direct consequence of this is problems of quality and yield arising, for example, from stoppage of the machines, often leading to significant costs. Furthermore, the cutting of the fibers limits the speed of the SMC manufacturing process.

An attempt is made in WO99/55521 to provide a glass fiber layer in an in-line process with a wet laying procedure. This method is complex and, as a result of the drying needed, requires extensive additional measures. Essential properties of the glass fiber non-woven fabrics are also not described.

WO01/19599 describes a method wherein a layer of unidirectional reinforcing fibers is inlaid in an SMC process, said reinforcing fibers also having cut fibers added to them. This method is particularly suitable for applications providing for the requirement of particular tensile strength in one preferred direction. However, essential properties of the glass fiber non-woven fabrics are not described.

WO2005/054559 discloses a method for manufacturing needled glass fiber mats that can be used for SMC-like components. However, the needling of a mat represents an additional and complex process step. However, essential properties of the glass fiber non-woven fabrics are not described. Needling can lead, under certain circumstances, to very durable strengthening of the non-woven fabrics. The flowability of the resin impregnated glass mats made from these glass fiber mats is therefore relatively low.

US2005/0082721 describes mats having glass fibers and plastics fibers. However, this document does not contain any mention of reaction resins. Essential properties of the mats are also not described.

It is apparent that currently available resin impregnated glass mats with cut fibers often fulfill the given purpose. However, manufacturing these resin impregnated glass mats is expensive, complex and prone to errors.

It is therefore a task of the invention to provide a method by means of which resin impregnated glass mats can be economically and reliably manufactured. The resin impregnated glass mats thereby produced should be able to be made into molded objects with a high level of surface quality. Furthermore, the resin impregnated glass mats are also to have adequate tensile strength.

Furthermore, the resin impregnated glass mats should also be capable of being simply processed, where the resin impregnated glass mats should have a high level of flowability. These and other tasks that are not explicitly stated, but which can be derived or discovered from the circumstances discussed above, are achieved by glass fiber non-woven fabrics having all the features of claim 1. Suitable developments of the glass fiber non-woven fabrics according to the invention are protected by the subclaims which refer back to claim 1.

Claim 10 offers a solution to the fundamental aim with regard to the resin impregnated glass mats. Methods for manufacturing the glass fiber non-woven fabrics according to the invention are the subject matter of claim 15.

The subject matter of the present invention is therefore glass fiber non-woven fabrics which comprise cut glass fibers, characterized in that the glass fiber non-woven fabric has an inhomogeneity of not more than 10%, a weight per unit area of at least 600 g/m² and a tensile strength of at least 10 N.

The glass fiber non-woven fabrics according to the invention therefore represent important intermediate products for the manufacturing of resin impregnated glass mats. Therefore, resin impregnated glass mats comprising the glass fiber non-woven fabrics according to the invention are also the subject matter of the present invention.

The present invention brings with it the following advantages:

The glass fiber non-woven fabrics according to the invention allow economical manufacturing of resin impregnated glass mats, in particular prepregs and/or sheet molding compounds (SMCs). In particular, the cutting of glass fibers during the process of manufacturing the resin impregnated glass mats can therefore be dispensed with. As a result, the process of manufacturing the resin impregnated glass mats can be simplified. This has consequential cost advantages.

The molded bodies obtained by hardening the resin impregnated glass mats have high tensile strength and high surface quality.

The resin impregnated glass mats obtainable by use of the glass fiber non-woven fabrics of the present invention can be processed by the known means. These resin impregnated glass mats have a high level of flowability, where the compression mould need only be covered to a relatively small extent. The tensile strength and stiffness can be varied across a wide spectrum depending on the reinforcing fiber material used.

The manufacturing of the resin impregnated glass mats can be carried out in a semi-closed process. This advantage results, in particular, from the low space requirements of the rollers from which the glass fiber non-woven fabrics are rolled out, when compared with conventional manufacturing with cut glass fibers. This means that the release of potentially hazardous chemicals to the environment is greatly reduced.

By means of the glass fiber non-woven fabrics according to the invention, expensive and fault-prone apparatus for cutting the glass fibers can surprisingly be dispensed with. This also includes all the additional components and devices, such as roving feeds, creels, monitoring apparatus, etc., which are associated with heavy costs due to the large number of rovings to be fed in. The costs for manufacturing the resin impregnated glass mats can therefore be reduced. Furthermore, the quality of the resin impregnated glass mats, and in particular the constancy of the quality, can be improved.

The glass fiber non-woven fabrics according to the invention comprise glass fibers. Glass fibers for manufacturing resin impregnated glass mats are per se widely known and have long been in use. Suitable glass fibers are described in, among other places, Ullmann's Encyclopaedia of Industrial Chemistry, 5th edition on CD-ROM (headword: fibers). Suitable glass fibers include those made from A-glass, E-glass, S-glass, C-glass, T-glass or R-glass.

The glass fibers preferably have a diameter in the range of 5 μm to 20 μm, particularly preferably 8 μm to 18 μm and especially preferably 10 μm to 15 μm.

According to a particular aspect of the present invention, the glass fibers may have a length in the range of 6 mm to 100 mm, preferably in the range of 10 mm to 75 mm and particularly preferably in the range of 15 mm to 60 mm, but without being restricted thereto.

The glass fiber non-woven fabric according to the invention has an inhomogeneity in the fiber distribution (weight per unit area) across the width of the non-woven fabric of less than 10%, and preferably less than 5%. The standard deviation of the mean weight per unit area distribution across the width of the non-woven fabric is preferably not more than 5%, particularly preferably not more than 2.5%. The inhomogeneity can be determined in accordance with ISO 3374.

The weight per unit area of the glass fiber non-woven fabric according to the invention preferably lies in the range of 600 g/m² to 2000 g/m², particularly preferably in the range of 800 g/m² to 1500 g/m² and especially preferably 900 g/m² to 1400 g/m². The weight per unit area is determined in accordance with ISO 3374.

The glass fiber non-woven fabric of the present invention preferably has a tensile strength in the range of 10 N to 200 N, particularly preferably 20 N to 150 N and especially preferably 25 N to 100 N. The tensile strength can be determined in accordance with ISO 3342 and relates to a sample width of 5 cm in each case.

The tensile strength of the glass fiber non-woven fabric can be achieved through the method for manufacturing the glass fiber non-woven fabric. Furthermore, the tensile strength can be increased by mechanical processes or by the use of binding agents. The tensile strength can therefore be mechanically increased by means of a needle loom.

Preferred binding agents comprise thermoplastics and/or reaction resins, which form cross-linked structures on heating. According to a particular aspect of the present invention, the binding agents used for strengthening the glass fiber non-woven fabric are chosen such that the binding agent is soluble to a reaction resin system.

Preferred thermoplastics contained in the binding agents comprise, among other things, polyolefins, for example polypropylene, polyesters, such as polyethylene terephthalate or polybutylene terephthalate, polyvinyl acetate and partially hydrolyzed polyvinyl acetate, polyvinyl chloride, polyalkyl(meth)acrylate, wherein the alcohol radical of the (meth)acrylate groups preferably contains 1 to 10 carbon atoms, such as, for example, polymethylmethacrylate, polyethylmethacrylate, acrylnitryl polymers, polyvinyl alcohols, polyvinyl pyrrolidones, styrene polymers, polyamides, in particular, nylon, copolymers derived from two or more of the above plastics, and mixtures of these plastics. The expression (meth)acrylate includes methacrylate, acrylate and mixtures of methacrylate and acrylate.

The reaction resins contained in the binding agents comprise, in particular, unsaturated polyester resins.

The plastics may have known functional groups. These comprise, in particular, acid groups and acid anhydride groups. These groups may be introduced into the plastics material during manufacturing of the aforementioned plastics, by copolymerization.

Preferred binding agents are hot melt adhesives having a low concentration of solvent. These binding agents therefore generally have particularly high proportions of the aforementioned plastics and/or reaction resins.

The plastics are preferably added to the glass fibers as plastics fibers. The plastics mentioned above may also be added to the glass fiber non-woven fabric as flakes, granules or as powder.

Unsaturated polyester resins may therefore also be added in powdered form.

Preferred plastics fibers have a length in the range of 6 mm to 75 mm, and particularly preferably 18 mm to 50 mm. The plastics fibers have a weight per unit length in the range of 2 dtex to 40 dtex, preferably 3 dtex to 30 dtex and particularly preferably 4 dtex to 7 dtex.

The glass fibers may also have known additives. Glass fibers can, for example, comprise known sizing agents with which the bonding properties of the glass fibers may be altered.

Preferably, the glass fiber non-woven fabric comprises at least 50% by weight, particularly preferably at least 70% by weight and especially preferably at least 90% by weight of inorganic glass.

Preferably, the glass fiber non-woven fabric comprises in the range of 0.1% by weight to 10% by weight, particularly preferably 0.2% by weight to 5% by weight and especially preferably 0.3% by weight to 2% by weight of binding agent relative to the weight of the glass fiber non-woven fabric. The weight relates to the dry weight of the binding agent if the binding agent is introduced in solution or as a suspension.

The glass fibers are preferably present in the form of bundles. The term “bundles” implies that the glass fibers have a certain degree of order in the longitudinal direction. Preferably, the bundles have in the range of 50 to 1000 glass fibers, particularly preferably 100 to 500 glass fibers and especially preferably 200 to 300 glass fibers. These values relate to a numerical mean value relative to the glass fiber non-woven fabric. A glass fiber belongs to a bundle if more than 50% of the length of the glass fiber is oriented in the longitudinal direction and is in contact with other glass fibers of the bundle over this length.

Preferably at least 50% by weight, and particularly preferably at least 70% by weight of the glass fibers, relative to the weight of the glass fibers, are present in the glass fiber non-woven fabric in the form of bundles.

The glass fiber bundles, also known as rovings preferably have a titer in the range of 20 tex to 200 tex, particularly preferably 30 tex to 160 tex and especially preferably 40 tex to 120 tex.

According to a particular aspect of the present invention, on mechanical loading, bundles separate partly into fibers if the glass fiber non-woven fabric is embedded in a resin impregnated glass mat. This property can be adjusted by the use of additives or preparations applied to the surface of the glass fibers.

The manufacturing of the glass fiber non-woven fabrics according to the invention can be carried out with known methods. Preferably, manufacturing takes place using dry processes for manufacturing the non-woven fabrics, in particular by carding or by methods wherein the fibers are formed into non-woven fabrics by streams of air (air laid). Both methods are known per se and are described, for example, in Ullmann's Encyclopaedia of Industrial Chemistry, 5th edition on CD-ROM (headword: non-woven fabrics). This method is also disclosed by US 2005/0082721.

Preferred devices for manufacturing the glass fiber non-woven fabrics by air-laid methods are described in WO 99/36622, WO 99/36623 and WO 2005/044529.

The adjustment of the individual process parameters, for example, the air pressure or air speed in an air-laid method or, for example, the properties of the rollers used in the carding method can be easily adjusted, since these methods and non-woven fabrics made with these methods have long been known.

The glass fiber non-woven fabrics according to the invention may be used, in particular, for manufacturing resin impregnated glass mats. Resin impregnated glass mats comprise, apart from the glass fiber non-woven fabric, at least one hardenable compound.

Any reaction resin that is normally used in the field of SMC or prepreg technology may be used, in particular, for manufacturing the resin impregnated glass mats according to the invention. Reaction resins of this type are described in detail in Ullmann's Encyclopaedia of Industrial Chemistry, 5th edition on CD-ROM.

These comprise, in particular, epoxy resins, unsaturated polyester resins, vinyl ester resins, polyimide resins, cyanate ester resins, phenolic resins, melamine resins and bismaleinimide resins.

Furthermore, the aforementioned resins can also be used as mixtures comprising two or more of these resin systems.

Preferably, reaction resins according to the invention based on unsaturated polyesters, which harden by undergoing polymerization and cross-linking to form thermosetting plastics masses can be used. Unsaturated polyester resins often contain as additional components copolymerizable monomers, such as styrene, alpha-methylstyrene, vinyltoluene, methylmethacrylate, which serve as solvents or thinners, as well as bifunctional monomers including divinylbenzene and diallylphthalate as cross-linking agents.

In order to harden the previously described reaction resin systems, catalysts are normally used. The catalysts are chosen depending on the reaction resin being used.

Unsaturated polyester resins or vinylester resins can generally be hardened by polymerization initiators, such as peroxides. An example of these is t-butyl-per-2-ethylhexanoate, bis-(4-t-butylcyclohexyl)-peroxydicarbonate, benzyl peroxide and methyl isobytylketone peroxide. These hardeners can also be used as mixtures.

For systems that comprise acrylate functions, UV photoinitiators can be used, like those that are set free, in particular, by a Lewis acid or a Brødstedt acid through irradiation. Examples include triaryl sulphonium salts which possess anions, for example, tetrafluoroborate or heaxafluoroborate.

According to a particular aspect of the present invention, the binding agent used for strengthening the glass fiber non-woven fabric is soluble in the reaction resin system. This has the surprising effect that the flowability of the resin impregnated glass mats obtained can be improved.

The reaction resins can also comprise additives, such as pigments, UV stabilizers, mould-release agents, fireproofing agents and shrinkage compensating additives.

The shrinkage compensating additives include, among other things, saturated polyesters, polyurethanes, polyvinylacetate, polymethylmethacrylate, polystyrene or styrene-butadiene copolymers or mixtures of these additives.

The resin impregnated glass mats according to the invention include, among other things, sheet-molding compounds (SMCs), which have a relatively high proportion of fillers, thickening agents and pigments, and prepregs, which have a smaller proportion of fillers, thickening agents and pigments.

SMC is a term which refers to resin impregnated glass mats according to DIN 16913. A typical SMC recipe includes approximately 15% to 45% by weight of reaction resin, 15% to 45% by weight of filler and 15% to 45% by weight of glass fiber non-woven fabric. The SMC recipe may also contain further additives, such as color pigments, hardeners, dispersing agents, thixotropic agents, thickening agents, bonding agents and/or releasing agents.

Thickening agents that may be used comprise alkali metal and/or alkaline earth metal oxides or hydroxides and/or isocyanates.

The manufacturing of SMCs can be carried out in known manner, although addition of the reinforcing fibers takes place in the form of at least one glass fiber non-woven fabric according to the invention.

According to a preferred method, a reaction resin mixture can first be placed on a support foil, said reaction resin mixture possibly comprising, apart from reaction resin, further additives and fillers. At least one layer of a fiber glass non-woven fabric according to the invention is wound off a winding roll and applied to the resin matrix. In a subsequent step, a layer of reaction resin, which may also comprise additives such as fillers, is applied to a second support foil. This second support foil is applied from above to the glass fiber non-woven fabric, the surface of the support foil, which is provided with reaction resin facing towards the glass fiber non-woven fabric. This structure is then transported through an impregnating line which brings about wetting of the fibers with the resin matrix by means of pressure and rocking motions. At the end of the machine, the product is wound onto rolls.

A curing process is normally carried out, which can be initiated using chemical and/or physical means. Preferably, the curing process lasts 0.5 to 14 days, and particularly preferably 1 to 7 days. Following this curing process, the SMC can be further processed. After pulling off the support foils, the SMC is usually processed and/or compressed in heated steel tools to make molded products.

A resin impregnated glass mat according to the invention preferably has a thickness in the range of 1 mm to 20 mm, and particularly preferably 2 mm to 10 mm. The weight per unit area of preferred resin impregnated glass mats preferably lies in the range of 500 g/m² to 6000 g/m², and particularly preferably 1000 g/m² to 4000 g/m².

The resin impregnated glass mats according to the present invention preferably have a high level of flowability. This dispenses with the necessity of placing the resin impregnated glass mat precisely positioned in the mould. Preferably, the flowability of the resin impregnated glass mat is sufficiently high that the compression mould preferably only has to be covered to an extent in the range of 25% to 80%, and particularly preferably 30% to 49%.

The resin impregnated glass mats according to the invention are versatile in use. They can be used, in particular, for the manufacturing of fiber-reinforced components which are required to provide good temperature and solvent-resistance as well as a high level of stiffness, tensile strength and impact resistance, even at low temperatures.

The components obtainable from resin impregnated glass mats can preferably have a class A surface quality.

The resin impregnated glass mats according to the invention are therefore particularly suitable for automobile parts. By reason of their good mechanical properties, resin impregnated glass mats are also an ideal material for the electrical, furniture and sanitary ware industries.

The surface of parts manufactured from resin impregnated glass mats can also be machined and treated by known means.

For example, foils or thin layer resins may be applied before or after the hardening of the resin impregnated glass mats.

For example, the resin impregnated glass mats may be provided with a layer of thermoplastic polymer in order to obtain an excellent surface quality after molding. Composite materials of this type are disclosed by, for example, EP 0 361 823 and EP 1 322 460.

1. Glass fiber non-woven fabric comprising cut glass fibers, characterized in that the glass fiber non-woven fabric has an inhomogeneity of 2.5% or less, a weight per unit area of 600 g/m2 or greater and a tensile strength of at least 10 N.

2. Glass fiber non-woven fabric according to claim 1, characterized in that the glass fibers are present in bundles.

3. Glass fiber non-woven fabric according to claim 2, characterized in that, on mechanical loading, the bundles can be partially separated into glass fibers.

4. Glass fiber non-woven fabric according to claim 2 or 3, characterized in that the bundles have 200 to 300 glass fibers.

5. Glass fiber non-woven fabric according to at least one of the preceding claims, characterized in that the glass fiber non-woven fabric has at least one binding agent.

6. Glass fiber non-woven fabric according to claim 5, characterized in that the binding agent comprises a hot melt adhesive.

7. Glass fiber non-woven fabric according to at least one of the preceding claims, characterized in that the glass fiber non-woven fabric has plastics fibers.

8. Glass fiber non-woven fabric according to at least one of the preceding claims, characterized in that the glass fibers have a length in the range of 6 mm to 75 mm.

9. Glass fiber non-woven fabric according to at least one of the preceding claims 2 to 8, characterized in that the bundles have a titer in the range of 30 tex to 160 tex.

10. Resin impregnated glass mat comprising at least one glass fiber non-woven fabric according to at least one of the claims 1 to 9.

11. Resin impregnated glass mat according to claim 10, characterized in that the resin impregnated glass mat comprises at least one reaction resin.

12. Resin impregnated glass mat according to claim 11, characterized in that the hardenable compound is an unsaturated polyester resin.

13. Resin impregnated glass mat according to one any of the claims 10 to 12, characterized in that the resin impregnated glass mat has a weight per unit area in the range of 500 g/m² to 6000 g/m².

14. Resin impregnated glass mat according to one any of the claims 10 to 13, characterized in that the glass fiber non-woven fabric used for manufacturing the resin impregnated glass mat comprises a binding agent which is soluble in the reaction resin used for manufacturing the resin impregnated glass mat.

15. Resin impregnated glass mat according to at least one of the claims 10 to 14, characterized in that the flowability of the resin impregnated glass mat is sufficiently high that a compression mould has only to be covered by 30% to 49%.

16. Method for manufacturing glass fiber non-woven fabrics according to one at least of the claims 1 to 9, characterized in that glass fibers are formed into a non-woven fabric by a carding method.

17. Method for manufacturing glass fiber non-woven fabrics according to at least one of the claims 1 to 9, characterized in that glass fibers are formed into a non-woven fabric by an air-laying process.

18. Use of glass fiber non-woven fabrics according to at least one of the claims 1 to 9 for manufacturing resin impregnated glass mats.

19. Use according to claim 18, characterized in that the resin impregnated glass mat is a sheet molding compound (SMC).
